(19) United States
(12) Patent Application Publication
(10) Pub. No.: US 2010/0114856 A1
(43) Pub. Date: May 6, 2010

(54) INFORMATION SEARCH APPARATUS, INFORMATION SEARCH METHOD, AND STORAGE MEDIUM

(75) Inventor: Hideo Kuboyama, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/608,715

(22) Filed: Oct. 29, 2009

(30) Foreign Application Priority Data
Oct. 31, 2008 (JP) 2008-281864

(51) Int. Cl. G06F 17/30; G06F 7/00

(52) U.S. Cl. 707/708; 707/E17.01; 707/E17.015

(57) ABSTRACT

The present invention provides a technique for determining a search range using metadata that is associated with information (file) of an image as well as determining granularity of the search range based on a unit of numerical information included in a query when a file is searched from a database. More particularly, an information search apparatus searches a plurality of files that include numerical information. As a query for determining the search range, a first numerical value and a keyword are input, a unit of the first numerical value is determined, the second numerical value of the unit that corresponds to the keyword is acquired, and a file included in the search range that is determined based on the first the second numerical values is searched from the plurality of files.

### BACKGROUND OF THE INVENTION

1. Field of the Invention

The present invention relates to a technique used for searching desired information from information stored in a storage medium.

2. Description of the Related Art

In recent years, along with the popularization of digital cameras and camera-equipped cellular phones, and further with the use of large-capacity memory cards, users tend to store captured images in the memory cards and select and reproduce a desired image whenever they want. However, it is not easy to search a desired image from among many images.

Conventionally, there have been methods for searching an image based on metadata that is added to the image. Images captured by digital cameras, for example, include metadata in exchangeable image file format (Exif). Thus, numerical information including shooting time and date as well as character string information such as scene information is added to the images.

The metadata may be manually added by the user or automatically added by a system. Japanese Patent Application Laid-Open No. 2006-166193 discusses a technique by which, if the user designates shooting time and date of the starting point as well as the end point corresponding to the search area, images with information that corresponds to the time and date of the search area are searched.

However, if the users do not remember the shooting time and date, it is difficult to efficiently search the desired image.

On the other hand, as another method, an image can be searched by the user designating information that relates to the scene of the image. However, in this case, the images that can be searched are limited to images having the information, which is related to the scene, designated by the user.

### SUMMARY OF THE INVENTION

The present invention is directed to an information search apparatus and method for efficiently searching images based on numerical information and character string information out of metadata that is associated with information (file) of images.

According to an aspect of the present invention, an information search apparatus configured to search a plurality of files including numerical information, the apparatus includes a processor wherein the processor includes inputting a first numerical value and a keyword as a query used for determining a range, determining a unit of the first numerical value, acquiring a second numerical value of the unit that corresponds to the keyword, searching the plurality of files and outputting a file included in the range determined based on the first and the second numerical values.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a functional block diagram illustrating an example of an information search apparatus according to a first exemplary embodiment of the present invention.

FIG. 2 is a flowchart illustrating information search processing according to the first exemplary embodiment.

FIG. 3 illustrates processing of a semantic information extraction unit extracting semantic information from a query.

FIG. 4 illustrates processing of a first information search unit searching information using a keyword included in the query.

FIG. 5 illustrates processing of a time range determination unit.

FIG. 6 illustrates a relationship between input query and a time range determined by the time range determination unit.

FIG. 7 is a functional block diagram illustrating an example of the information search apparatus according to a second exemplary embodiment of the present invention.

FIG. 8 is a functional block diagram illustrating an example of the information search apparatus according to a fourth exemplary embodiment of the present invention.

FIG. 9 illustrates position range determination processing according to the fourth exemplary embodiment.

FIG. 10 is a flowchart illustrating time range determination processing according to a third exemplary embodiment of the present invention.

FIG. 11 is a flowchart illustrating processing of the fourth exemplary embodiment.

### DESCRIPTION OF THE EMBODIMENTS

Various exemplary embodiments, features, and aspects of the invention will be described in detail below with reference to the drawings.

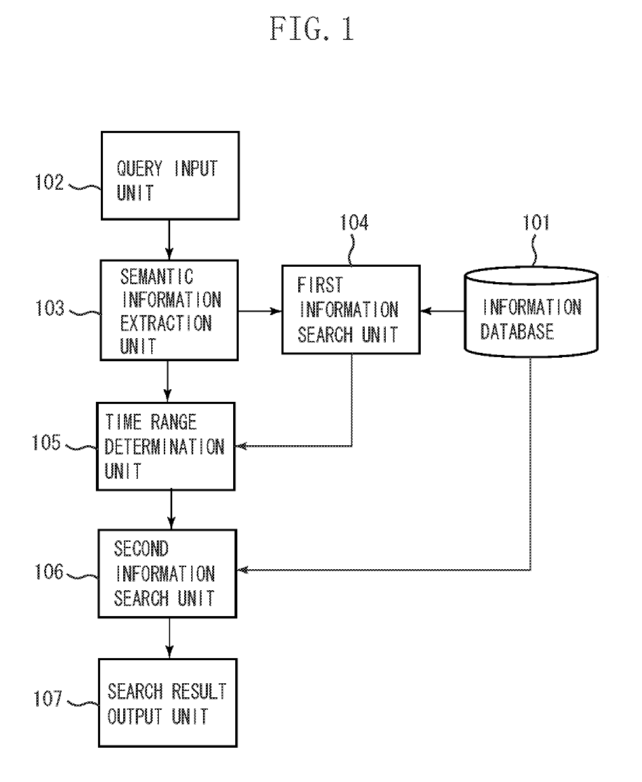

FIG. 1 is a functional block diagram illustrating an example of an information search apparatus according to a first exemplary embodiment of the present invention.

The above-described information search apparatus includes an information database 101, a query input unit 102, a semantic information extraction unit 103, a first information search unit 104, a time range determination unit 105, a second information search unit 106, and a search result output unit 107. In FIG. 1, information (file) as the search object is included in the information database 101. The information database 101 is stored in a recording medium such as a flash memory or a hard disk.

Although the information database 101 is in the information search apparatus according to the present embodiment, the information database 101 can be arranged outside of the information search apparatus and connected to the information search apparatus by a network.

Further, metadata describing time and date, scene, creator, and creation condition is associated to each file. A case where a plurality of files described above are searched will be described according to the present embodiment.

The query input unit 102, the semantic information extraction unit 103, the first information search unit 104, the time range determination unit 105, the second information search unit 106, and the search result output unit 107 are modules used for searching the files. The functions of these modules are realized by a central processing unit (CPU) by loading a program stored in a read-only memory (ROM) into a random access memory (RAM) and executing the program.

The query input unit 102 is used for inputting a query that is used for searching the information (file). The query is a request for processing which is performed when the information (file) that satisfies the designated condition is searched from the information database, and is data of a plurality of words that are connected.

The semantic information extraction unit 103 acquires semantic information such as a keyword used for determining time information and the information (file) based on the query. The time information is information used for designating time and date and includes numerical information and time unit information. The keyword is, for example, a character string that corresponds to the metadata that is associated with the information (file).

The metadata may be included in a table that is associated with IDs that represent the information (file) and may also be information that is added to the information (file) like the known Exif. The Exif information includes information that is automatically added when an image is generated or information that the user can manually and arbitrarily add to the image. Information indicating time and date, scene, and image capture conditions can be included in the Exif information.

The first information search unit 104 searches the information database 101 for the information (file) that is associated with the metadata that corresponds to the extracted keyword. Further, the first information search unit 104 acquires metadata that describes the time and date and the scene that are associated with the searched information (file).

The time range determination unit 105 determines a time range as a search range based on the time information extracted by the semantic information extraction unit 103 and the metadata that describes the time and date searched by the first information search unit 104.

Based on the time range determined by the time range determination unit 105, the second information search unit 106 searches the information database 101 for the information (file) with which the metadata that describes the time and date that corresponds to the determined time range is associated.

The search result output unit 107 outputs information regarding the information (file), which the second information search unit 106 has searched as a search result.

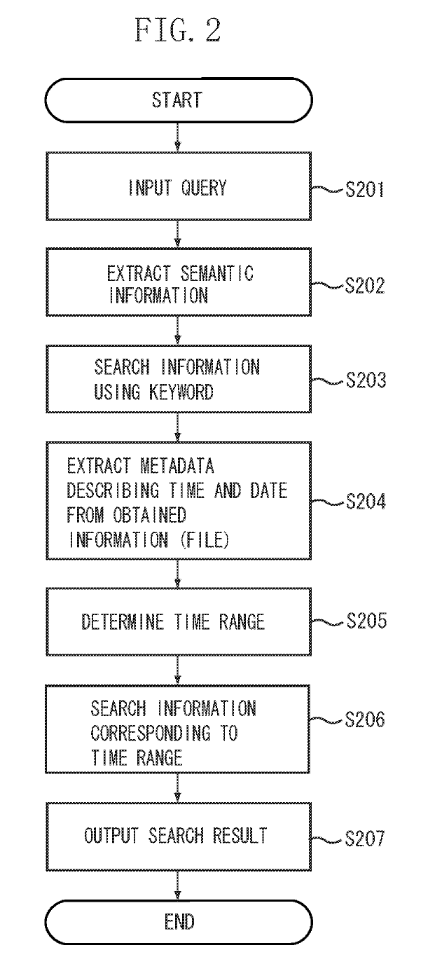

FIG. 2 is a flowchart illustrating information search processing according to the present exemplary embodiment. Process flow of the information search according to the present exemplary embodiment will now be described referring to FIGS. 1 and 2.

In step S201, the query input unit 102 accepts a query as an input. Although the query can take various forms such as a text or a voice, a query in a text form is described in the present embodiment.

In step S202, the semantic information extraction unit 103 extracts semantic information from the query. In step S203, the first information search unit 104 searches the information using a keyword included in the semantic information.

In step S204, metadata describing the time and date that is associated with the information (file), which is searched by the first information search unit 104, is acquired, and the acquired time and date information is output to the time range determination unit 105.

In step S205, the time range determination unit 105 determines the time range based on the time information extracted by the semantic information extraction unit 103 and the metadata that describes time and date associated with the information (file) searched by the first information search unit 104.

The time information extracted by the semantic information extraction unit 103 includes time unit information (e.g., year, month, day, hour, minute, and second). Further, the time information includes numerical information (first numerical information) of the designated time (e.g., 1 to 12 if the time unit is “month” and 0 to 59 if the time unit is “minute” or “second”).

Based on this time unit information, granularity that is used for determining the time range from the time and date information that is associated with the information (file) searched by the first information search unit 104 is determined. When the granularity is determined and, further, the time range is determined, in step S206, the second information search unit 106 searches the information database 101 for the information (file) that corresponds to the time range.

In step S207, the search result output unit 107 outputs information of the searched information (file) as a search result.

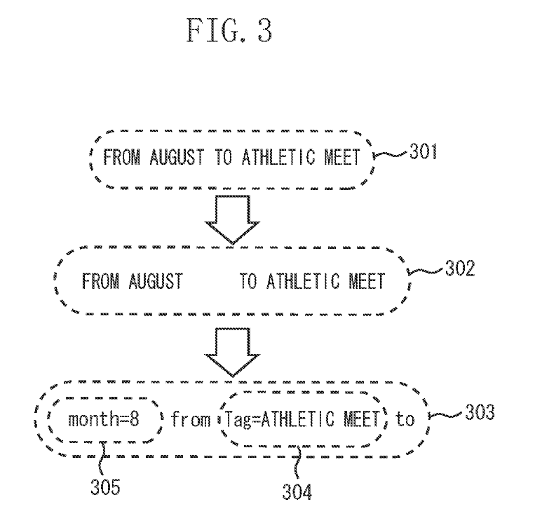

FIG. 3 is a schematic diagram illustrating processing of the semantic information extraction unit 103 that extracts semantic information from the query. This processing corresponds to the processing in step S202 in FIG. 2.

In FIG. 3, the semantic information extraction unit 103 divides a query 301 into words. The word is a unit that configures the query. The word has a certain meaning and plays a certain grammatical role. The query can be divided into words using, for example, morphological analysis. A result 302 illustrates a result of the query that is divided into words.

The semantic information extraction unit 103 extracts semantic information that corresponds to each word from each of the words. Semantic information that corresponds to each word is included in the word dictionary used for the morphological analysis. By reading out the word dictionary, the semantic information corresponding to each word can be extracted.

A keyword 304 is included in semantic information 303. The first information search unit 104 searches the information database 101 for information (file) that is associated with the metadata that describes the scene corresponding to the keyword (character string “athletic meet” in FIG. 3).

Time unit information 305 is included in the semantic information. The time unit of the time unit information is, for example, year, month, day, hour, minute, and second. The time unit information 305 is used for determining the granularity that is used out of the metadata that describes the time and date that is associated with the information (file) detected by the first information search unit 104. The granularity is a unit that is used when the data is segmented, and the time granularity includes year, month, day, and time.

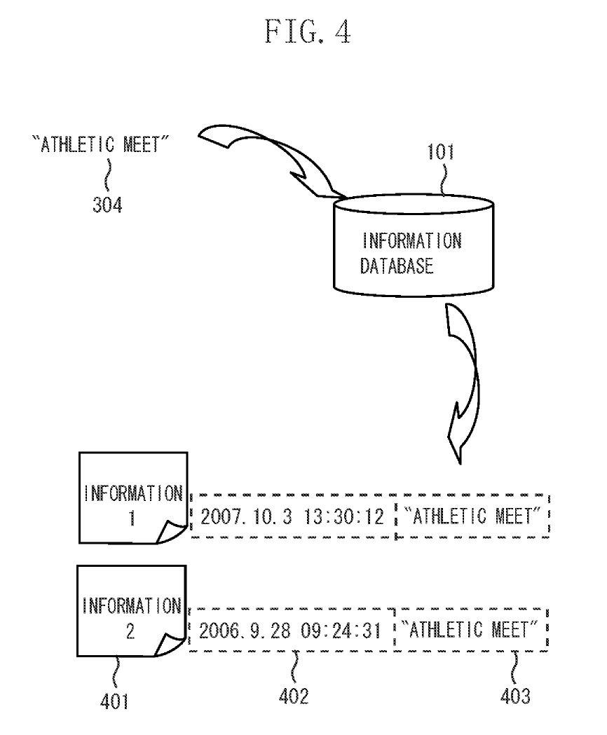

FIG. 4 illustrates the first information search unit 104 performing the search based on the keyword 304 that is included in the query. This processing corresponds to the processing in steps S203 and S204 in FIG. 2.

In FIG. 4, information (file) 401 is detected by the information search unit 104. Metadata that describes a scene corresponding to the keyword (“athletic meet”) of a search condition is associated with the information (file) 401. The metadata 402 describes the time and date associated with the searched information (file) 401.

Metadata 403 describes a scene associated with the searched information (file) 401. If information (file) having the metadata describing a scene that corresponds to the keyword (“athletic meet”) is searched in a state illustrated in FIG. 4, the information (file) 401 having the “athletic meet” in the metadata 403 that describes the scene is searched from the information database 101.

The first information search unit 104 extracts the metadata 402 describing the time and date associated with the searched information (file) 401 and outputs the extracted metadata 402 to the time range determination unit 105.

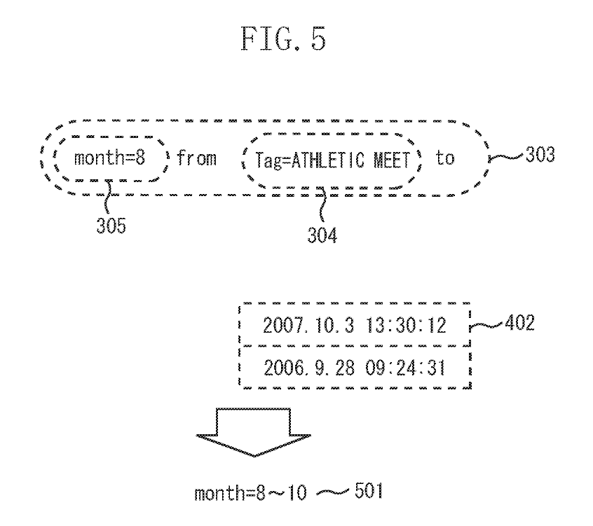

FIG. 5 illustrates processing of the time range determination unit 105. This processing corresponds to the processing in step S205 in FIG. 2.

The time range determination unit 105 acquires the semantic information 303 from the semantic information extraction unit 103 and acquires the metadata 402 describing the time and date that is associated with the information (file) that is searched by the first information search unit 104.

Then, the time range determination unit 105 sets the time information determined based on the metadata 402 that describes the time and date in the portion of the keyword 304 included in the semantic information 303. Then, the time range determination unit 105 determines the range of the time information.

As illustrated in FIG. 5, the time range is designated using the semantic information “from” that indicates the starting point of the range and also the semantic information “to” that indicates the end point of the range. However, the semantic information used for designating the range is not limited to this. For example, “or” can also be used. By using the semantic information “or”, a plurality of time points can be designated.

The unit that is set for the keyword 304 is determined based on the time unit information 305 that is included in the semantic information 303.

In FIG. 5, the semantic information 303 includes the time unit information 305 (“month”) that represents month. Thus, two pieces of numerical information (second numerical value) “10” and “9” that correspond to the time unit information 305 (i.e., month, according to the present embodiment) are extracted from the metadata 402 describing the time and date associated with each of the two pieces of information (files) that are searched by the first information search unit 104.

Next, by using the extracted numerical information (the second numerical information) “10” and “9”, the time range that includes all the information (file) that is searched by the first information search unit 104 is determined. For example, as illustrated in FIG. 5, the time range is designated by “from” and “to” by the query. The starting point of the time range is designated by numerical information (first numerical value) and the end point of the time range is designated by numerical information (second numerical value).

At this time, the numerical information (the second numerical value) is determined to be either “10” or “9” so that both of the two pieces of information (files) searched by the first information search unit 104 are included in the range. Thus, in this case, “10” is employed as the numerical information (the second numerical information), and the time range will be “from August to October”.

A time range 501 illustrated in FIG. 5 is determined according to the above-described method. “month: 8 to 10” indicates that the information (file) that is associated with the metadata describing the time and date from August to October out of the plurality of files stored in the information database 101 is the search target.

At this time, unit information such as year, day, and hour can be additionally set based on the metadata describing the time and date associated with the searched information (file), and a predetermined time range such as the current year can be set as the search target.

By performing the setting as described above, not all of the files stored in the database 101 but the information (file) that is associated with the current year as the metadata describing the time and date can be set as the search target.

Next, the determined time range is output to the second information search unit 106. The second information search unit 106 searches the information database 101 for the information (file) that is associated with the metadata describing the time and date that satisfies the condition, based on the information corresponding to the time range output from the time range determination unit 105.

Thus, if the information (file) is searched using the time range “month: 8 to 10” as illustrated in FIG. 5, then the information corresponding to the metadata having the time and date in association with the information (file) from August to October is searched. In other words, information (file) that is not associated with the metadata describing a scene corresponding to the keyword (“athletic meet”) included in the query is searched as well.

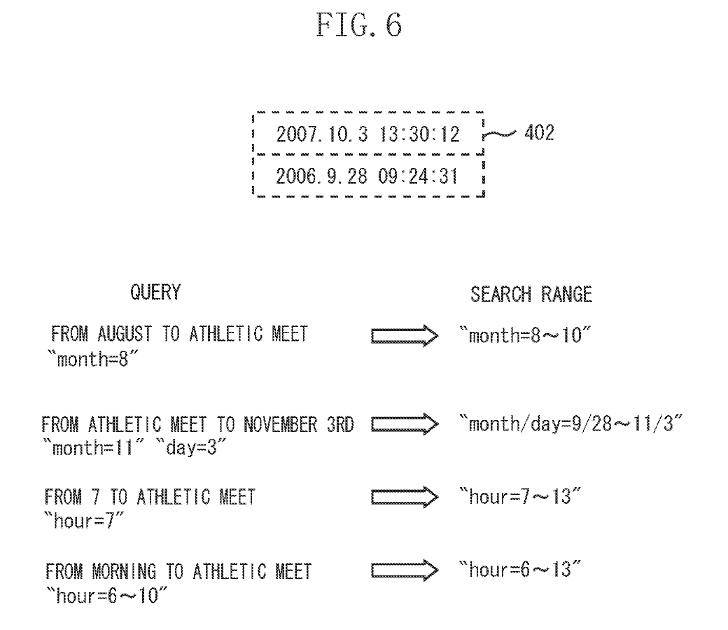

FIG. 6 illustrates a relationship between an input query and a time range determined by the time range determination unit 105. In FIG. 6, if a query such as “from August to athletic meet” is input, the time unit information 305 (“month” in this case) is obtained from the word “August”. Thus, by using a value that corresponds to “month” out of the metadata 402 that describes time and date, a time range of “month: 8 to 10” (month from August to October) is set.

Further, if a query such as “from athletic meet to November 3rd” is input, the time unit information 305 (“month” and “day” in this case) is obtained from the words “November” and “3”. Thus, by using values that correspond to the “month” and the “date” out of the metadata 402 describing the time and date, a time range of “month/day: 9/28 to 11/3” is set.

In this case, the files, which are associated with metadata describing the time and date corresponding to September 28 to November 3, will be the target of the search. Further, if a query such as “from 7 o'clock to athletic meet” is input, the time unit information 305 (“hour” in this case) is acquired from the word “hour”.

Thus, the range is set as “hour: 7 to 13” by using the values that correspond to “hour” out of the metadata 402 that describes the time and date. In this case, the file whose metadata describes the time and date that corresponds to the time “from 7 o'clock to 13 o'clock” will be the search object.

In other words, even if the same keyword (“athletic meet”) is used, time range of different granularity is set depending on the time unit information included in the query. Further, the word that holds the time unit information as semantic information may not directly indicate time such as “7 o'clock” or “August”.

For example, semantic information of “hour=6 to 10” is set in advance for a word “morning”. Then, as illustrated in FIG. 6, if a query such as “from morning to athletic meet” is input, then the time unit information of “hour” is extracted from the word “morning”. Further, by using the time range “hour=6 to 10” obtained from the word “morning” and a value that corresponds to the “hour” out of the metadata 402 that describes the time and date, the search range is set to “hour=6 to 13”.

In this case, the information (file) that corresponds to 6 o'clock to 13 o'clock of the metadata 402 that describes the time and data that is associated with the file will be the search target. In this way, a file whose metadata corresponds to the keyword is searched based on the keyword that is included in the query.

Further, by extracting the metadata that describes the time and data from the information (file) and, further, by determining the time range based on the time unit information included in the query, a flexible search using tag information can be realized.

According to the above-described exemplary embodiment, the query input unit inputs a query in the form of a text and then the semantic information extraction unit 103 extracts the semantic information by dividing the text of the query into words. However, in another exemplary embodiment, the query can be input in the form of a voice. In this case, the voice query is voice-recognized and semantic information is extracted from the result of the voice recognition.

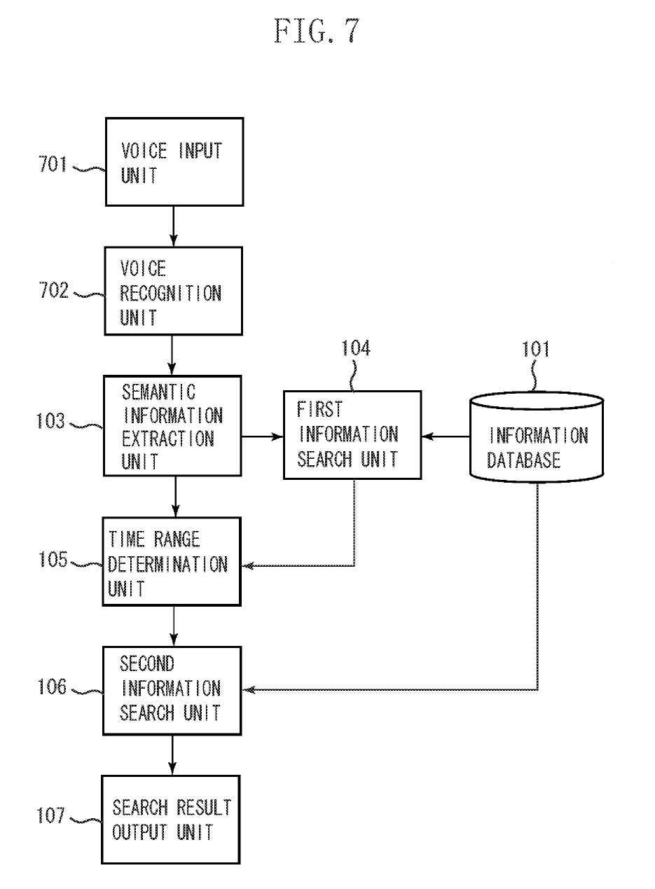

A functional block diagram of the present exemplary embodiment is illustrated in FIG. 7. In FIG. 7, a voice input unit 701 receives voice and a voice recognition unit 702 recognizes the input voice. The voice recognition unit 702 includes voice recognition grammar that indicates the pattern of the word to be recognized. The voice recognition unit 702 sends a recognition result of the voice, which is closest to the pattern of the voice recognition grammar to the semantic information extraction unit 103.

By adding semantic information to each recognition word of the recognition grammar in advance, the semantic information extraction unit can extract semantic information without using morphological analysis or a word dictionary.

According to the above-described exemplary embodiments, as illustrated FIG. 6, only the range that is related to the time unit of the time unit information included in the query is determined as the time range of the search. However, the range of the search of the present invention is not limited to such a range and can be a combination with a predetermined search conditions.

For example, in FIG. 6, according to the query “from August to athletic meet”, the time range is set to “month: 8 to 10”. This means that all the information included in the months from August to October is searched even if the information is of different years. According to the present invention, information in the time range “from August to October of this year” can be searched according to the current time and date.

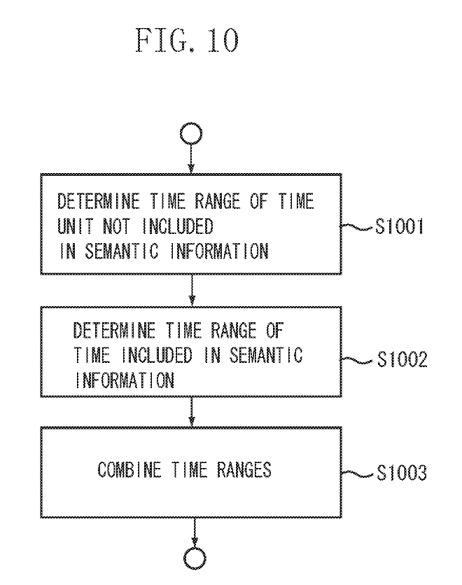

FIG. 10 is a flowchart illustrating the time range determination processing executed by the time range determination unit 105 in step S205 in FIG. 2 according to the present exemplary embodiment.

In step S1001, the time range determination unit 105 determines the range of the time unit that is not included in the semantic information. For example, if the time unit is “year”, then the range can be set as “2007” based on the current time and date, or the range can be set as “2006 to 2007” based on the metadata 402 that describes the time and date.

In step S1002, the time range determination unit 105 determines the range of the time unit that is included in the semantic information. As is with the above-described exemplary embodiments, a time range of “August to October” is obtained.

In step S1003, the time ranges are combined. For example, if the year is set based on the current time and date, “from August 2007 to October 2007” can be obtained. Further, if the year is set based on the metadata 402 that describes the time and date, “from August 2006 to October 2006 or from August 2007 to October 2007” can be obtained.

Further, the flowchart in FIG. 10 can be applied for each metadata 402 that describes the time and date, and the time range can be combined after the time range for each metadata is determined.

In other words, in step S1001, if the time range concerning year is obtained from each of the metadata 402 that describes the time and date, then “2007” and “2006” will be obtained. Further, if the range of the time unit that is included in the semantic information is obtained from each of the metadata 402 in step S1002, then “August to October” and “August to September” can be obtained.

In combining the time ranges in step S1003, the time ranges are combined for each metadata 402 that describes the time and date, and then “August 2007 to October 2007” and “August 2006 to September 2006” are obtained. Further, by combining these to obtain a time range that satisfies both of the time ranges, a time range of “August 2007 to October or August 2006 to September” is obtained.

Further, according to the above-described exemplary embodiments, the time range is determined so that it includes all of the metadata 402 that describes the plurality of times and dates obtained from the plurality pieces of information searched by the first information search unit 104.

However, the time range of the present invention is not limited to this and, for example, the time range can be determined by using only the metadata 402 that describes the time and date that falls in the predetermined time period such as “the current year” or “a predetermined year”.

Further, the time range can be determined by using only the metadata 402 that describes the time and date that is closest to the current time or a predetermined time. For example, in FIG. 6, if only the information of 2007 is used, then the time range is determined based only on the metadata 402 that describes the time and date (“2007.10.3 13:30:12”). Thus, if a query such as “from athletic meet to November 3rd” is input, then the time range of the search will be “month/day: 10/3 to 11/3” (from October 3rd to November 3rd).

The present exemplary embodiment is realized by the first information search unit 104 performing search, based on a keyword, of only the information (file) of the current year or of only the information (file) that is closest to the current time.

According to the above-described exemplary embodiments, the granularity of the time and date is determined based on the time unit information included in the query. However, the granularity of the present invention is not limited to time, and other numerical information can be used so long as a range can be designated.

For example, the information (file) can be searched based on information such as global positioning system (GPS) information that includes position information (e.g., numerical information of latitude and longitude). In this case, the granularity of the position will be latitude/longitude, minute, and second. Address units such as prefecture, municipality, ward, street, and house number can also be used.

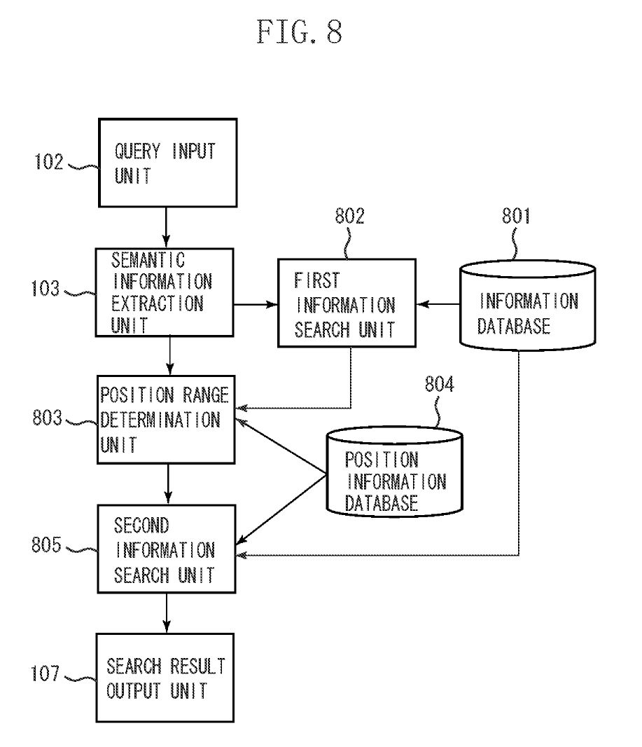

A functional block diagram when the position information is used in determining the range is illustrated in FIG. 8. In FIG. 8, an information database 801 stores information (file) to be searched. The information (file) stored in the information database includes metadata (latitude information, longitude information) that describes position such as GPS information.

A first information search unit 802 searches information based on the keyword extracted by the semantic information extraction unit 103. A position range determination unit 803 determines a position range used for the search based on the semantic information extracted by the semantic information extraction unit 103 and the metadata (latitude information, longitude information) that describes position and included in the information (file) that is searched by the first information search unit 802.

A position information database 804 stores position information that is used for matching position information such as GPS information with address information including prefecture, city, and ward. A second information search unit 805 searches the information database 801 for information (file) based on the position range determined by the position range determination unit 803.

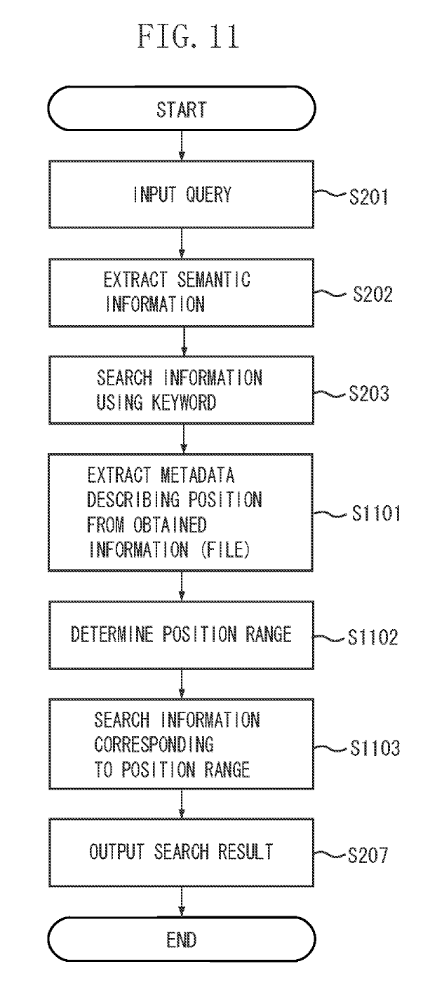

FIG. 11 is a flowchart illustrating the processes of the present exemplary embodiment. Since the processes in steps S201 to S203 are similar to those of the above-described exemplary embodiments, their description will be omitted.

In step S1101, the position range determination unit 803 extracts the metadata (latitude information, longitude information) that describes position from the information (file) searched by the first information search unit 802.

In step S1102, the position range determination unit 803 determines the position range based on the metadata (latitude information, longitude information) that describes the position, which is extracted from the information (file) searched by the first information search unit 802, and the semantic information extracted in step S202.

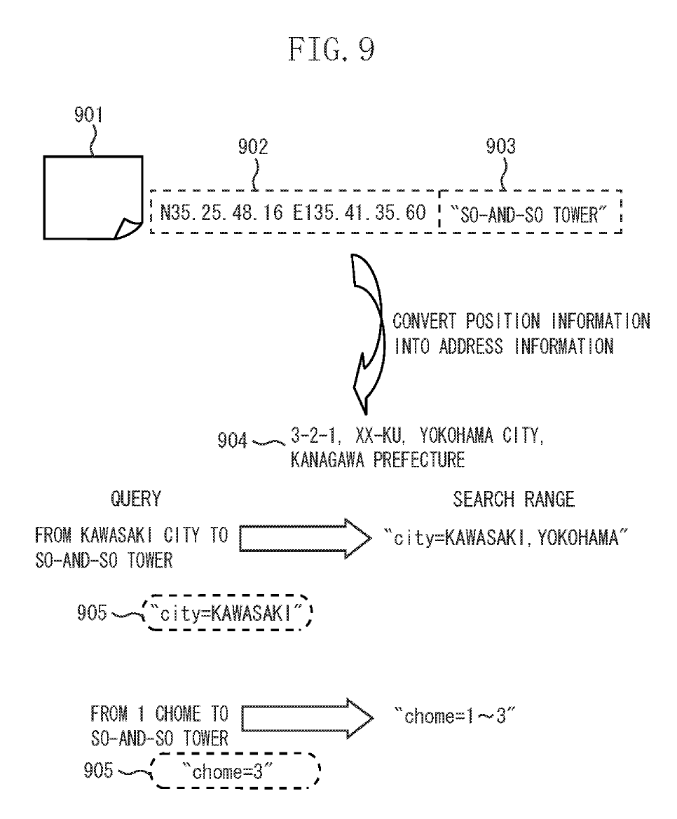

FIG. 9 illustrates the processes of steps S1101 and S1102. Information (file) 901 is searched by the first information search unit 802 by using a keyword (“so-and-so tower”). Metadata 902 describes position in the GPS information included in the information (file) 901. Metadata 903 is included in the information (file) 901 and includes tag information of a landmark. Address information 904 is created by referring to the position information database 804 and converting the metadata 902 that describes position.

The address information 904 can be obtained by converting the metadata 902 that describes the position, which is used when the position range determination unit 803 obtains the position range, or the address information 904 can be stored in advance in the information (file) 901 as metadata (metadata that describes address).

Position unit information 905 is information of position unit such as prefecture, city, and chome included in the semantic information that is extracted by the semantic information extraction unit 103. The position range determination unit 803 converts the metadata that describes the position, which is extracted from the information (file) that is searched by the first information search unit 802, into the address information 904 by referring to the position information database 804. The position range determination unit 803 determines the position range based on the address information 904 and the position unit information included in the semantic information.

In FIG. 9, the address information 904 (“Kanagawa prefecture, Yokohama city, XX ward, 3-2-1”) is obtained based on the keyword (“so-and-so tower”) included in the query. If the query is “from Kawasaki city to so-and-so tower”, then “city” is obtained as the position unit information. Thus, “Yokohama city” is extracted from the address information 904 and the search range is determined as “city: Kawasaki, Yokohama” (Kawasaki city or Yokohama city).

On the other hand, if the query is “1 chome to so-and-so tower”, then since “chome” is obtained as the position unit information, “3 chome” is extracted from the address information 904 and the search range is determined as “chome: 1 to 3” (1 chome to 3 chome). The granularity of the position at this time is “chome”.

Based on the position range determined in this way, in step S1103, the second information search unit 805 searches the information database 801 for information. The process in S207 is similar to the process described in the above-described exemplary embodiments.

As described above, the information (file), which is associated with the metadata (tag information) that corresponds to the keyword included in the query, is searched. Further, the metadata that describes the position is extracted from the information (file). Then, by determining the position range based on the position unit information included in the query, flexible search of the position range becomes possible.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-281864, filed Oct. 31, 2008, which is hereby incorporated by reference herein in its entirety.

What is claimed is:

1. An information search apparatus configured to search a plurality of files including numerical information, the apparatus comprising:
a processor, wherein the processor comprises:
inputting a first numerical value and a keyword as a query used for determining a range;
determining a unit of the first numerical value;
acquiring a second numerical value of the unit that corresponds to the keyword;
searching the plurality of files and outputting a file included in the range determined based on the first and the second numerical values.

2. The information search apparatus according to claim 1, wherein the first numerical value and the keyword are information obtained as a result of voice recognition.

3. The information search apparatus according to claim 1, wherein the second numerical value is information acquired from a file including tag information corresponding to the keyword.

4. The information search apparatus according to claim 1, wherein the numerical value represents time, and the unit is a unit concerning segmentation of time.

5. The information search apparatus according to claim 1, wherein the numerical value represents position, and the unit is a unit concerning segmentation of position.

6. The information search apparatus according to claim 1, wherein the keyword is a character string other than a numerical value used for obtaining the second numerical value.

7. A method for searching a plurality of files including numerical information, the method comprising:
inputting a first numerical value and a keyword as a query used for determining a range;
determining a unit of the first numerical value;
acquiring a second numerical value of the unit corresponding to the keyword; and
searching the plurality of files for a file and outputting the file included in a range determined based on the first and the second numerical values.

8. A computer-readable storage medium storing computer-executable process steps for causing a computer to execute the method according to claim 7.
